(19) United States
(12) Patent Application Publication
(10) Pub. No.: US 2017/0317377 A1
(43) Pub. Date: Nov. 2, 2017

(54) SECONDARY BATTERY, ELECTRIC VEHICLE, POWER STORAGE SYSTEM, AND MANUFACTURING METHOD

(71) Applicant: NEC Corporation, Tokyo (JP)

(72) Inventors: Kazuhiko INOUE, Tokyo (JP); Kenichi SHIMURA, Tokyo (JP); Shinya SUDO, Tokyo (JP); Noboru YOSHIDA, Tokyo (JP)

(73) Assignee: NEC Corporation, Tokyo (JP)

(21) Appl. No.: 15/521,030

(22) PCT Filed: Oct. 27, 2015
(86) PCT No.: PCT/JP2015/080092

§ 371 Date: Apr. 21, 2017

(30) Foreign Application Priority Data
Oct. 27, 2014 (JP) 2014-218008

(51) Int. Cl. H01M 10/05; H01M 2/02; H01M 10/04

(52) U.S. Cl. CPC H01M 10/05; H01M 10/049; H01M 2/02; H01M 2220/20; H01M 2220/10

(57) ABSTRACT

In the present invention, a secondary battery comprises: a battery element (20) in which a positive pole plate and a negative pole plate are layered; a housing (10) for housing the battery element (20) and an electrolyte; electrode tabs (21, 25) of the positive electrode and the negative electrode that are led out from the housing (10); a fusing part (25b) that is formed in a part of the electrode tab and preferentially fuses if a predetermined current has flowed; and a reinforcing member (33) which is attached to an electrode tab at least at the section having the fusing part (25b), and which is attached so as to be separated from the housing.

### TECHNICAL FIELD

The present invention relates to a secondary battery and the like, and particularly, relates to a secondary battery and the like having a structure in which an electrode tab and the like is provided with a fuse function that is further improved in reliability.

### BACKGROUND ART

There has been recently a strong demand for a compact and lightweight battery for use as a power supply of an electronic device, an automobile, and the like, and there are an increasing number of battery housings that use a laminated film instead of a conventional metal can. The laminated film generally uses, for example, aluminum as a metal thin film, and nylon (Registered Trademark) on a battery outer surface and polyethylene or polypropylene on an inner surface as thermally weldable resin films. A film packed battery contains a battery element and an electrolyte solution inside a housing made from such a laminated film (also referred to as a “film housing”). The film packed battery is configured such that electrode tabs of a positive electrode and a negative electrode are led out from the battery element and the respective electrode tabs extend to outside of the film housing.

Incidentally, as one safety countermeasure for a battery, it is known that a part functioning as a fuse is formed on a part of an electrode tab and the part preferentially fuses when a predetermined or more current flows (for example, see Patent Literature 1 (PTL1)).

### CITATION LIST

### Patent Literature

[PTL1] Japanese Laid-Open Patent No. 2007-335290

### SUMMARY OF INVENTION

### Technical Problem

PTL1 above discloses that an electrode tab led out from a film housing is provided with a notched part so that the part may be bent, and the notched part may function as a fuse. The notched part of the electrode tab is covered with an insulating resin. Although PTL1 suggests that a part of the electrode tab may function as a fuse, there is no specific description about an influence of heat or the like to be generated at the part when the part actually functions as a fuse. When a battery is provided with such a fuse function, careful consideration needs to be given to whether a fuse portion normally fuses, and whether heat to be generated by the portion adversely affects another part of the battery. Such a problem is not specific to a film packed battery, but may also arise similarly in a secondary battery of another type.

The invention of the present application has been made in light of the point described above, and an object of the present invention is to provide a secondary battery and the like having a structure in which an electrode tab is provided with a fuse function that is further improved in reliability.

### Solution to Problem

A secondary battery according to one mode of the present invention achieving the above-mentioned object is as follows:

A secondary battery comprising:

a battery element of stacked positive electrode plate and negative electrode plate;

a housing that houses the battery element and an electrolyte solution; and

electrode tabs of a positive electrode and a negative electrode that are led out from the housing,

the secondary battery further comprising:

a fusing part that is formed on a part of the electrode tab and preferentially fuses rather than another region when a predetermined current flows; and

a reinforcing member that is attached to the electrode tab at a section including at least the fusing part in a state that the reinforcing member is distant from the housing.

### Description of Terminologies

A “secondary battery” includes, as well as a battery that uses a film housing such as a laminated film (film packed battery), a battery that uses a hard container such as a metal can and a resin case as a housing. Examples of the outer shape of the battery include a flat shape (thin shape), a square shape, a cylindrical shape, a coin shape, and a button shape.

A “film packed battery” refers to a battery that houses a battery element and an electrolyte solution in a film housing, and generally has a flat shape as a whole. Since a battery for an electric vehicle, for example, is required to have a large capacity, a low internal resistance, a high heat dissipation performance, and the like, the film packed battery is advantageous in these points. A single film packed battery may be referred to as a “battery cell” or simply as a “cell”.

A “film housing” refers to a housing that is constituted by a flexible film and houses a battery element, and may be a housing that tightly seals a battery element by oppositely disposed two films being welded to each other, or may be a housing that tightly seals a battery element by opposite faces of a single folded-back film being welded to each other.

A “housing”, when referring simply to a housing, includes both a housing without flexibility (for example, a hard case) and a housing with flexibility such as the film housing described above.

A “fusing part” may be a region formed to have a partially small cross-section, or may be a region that preferentially fuses rather than another part by being constituted from a material having a melting point lower than that of the other part.

A “power supply unit” (assembled battery) is a unit that can be used in a vehicle, a predetermined system, and the like, and includes a plurality of secondary batteries (cells). The plurality of cells may be or may not be equipped in a state to be sub-assembled for some of cells. A unit equipped with a plurality of cells in a state to be sub-assembled for some of cells may be configured to be equipped with, for example, one or more predetermined cases fabricated as “battery packs” for housing the cells.

### Advantageous Effects of Invention

The present invention is able to provide a secondary battery and the like having a structure in which an electrode tab is provided with a fuse function that is further improved in reliability.

### BRIEF DESCRIPTION OF DRAWINGS

FIG. 1 is a perspective view of a film packed battery.

FIG. 2 is a cross-sectional view illustrating a part of a cross-section of the battery of FIG. 1.

FIG. 3 is a plan view schematically illustrating a configuration of an electrode tab of a battery according to one mode of the present invention.

FIG. 4A is a view illustrating a configuration of an electrode tab and a reinforcing member according to one aspect.

FIG. 4B is a view illustrating a configuration of an electrode tab and a reinforcing member according to another aspect (in which locking pieces are omitted).

FIG. 4C is a view illustrating a configuration of an electrode tab and a reinforcing member according to still another aspect.

FIG. 4D is a view illustrating a configuration of an electrode tab and a reinforcing member according to a different aspect.

FIG. 5A is a view illustrating a configuration of an electrode tab and a reinforcing member according to a still different aspect.

FIG. 5B is a perspective view of one example of a reinforcing member.

FIG. 5C is a modified example of a type of the reinforcing member of FIG. 5A.

FIG. 6 is a view illustrating an example of a fusing part formed on an electrode tab.

FIG. 7 is a view illustrating two examples of a fusing part formed on another conductive material connected to an electrode tab.

FIG. 8 is a schematic view of a power storage system.

FIG. 9 is a schematic view of an electric vehicle.

FIG. 10A is a view illustrating an example of a battery pack housed in a battery unit as an assembled battery.

FIG. 10B is a view illustrating elements of the battery pack of FIG. 10A.

FIG. 10C is a view illustrating a single body of the film packed battery in the battery unit of FIG. 10A.

FIG. 10D is a view illustrating an example of a battery unit as an assembled battery.

FIG. 11A is a view illustrating another example of a battery pack housed in a battery unit as an assembled battery.

FIG. 11B is a view illustrating elements of the battery pack of FIG. 11A.

FIG. 11C is a view illustrating another example of a battery unit as an assembled battery.

### DESCRIPTION OF EMBODIMENTS

Example embodiments of the present invention will be described below with reference to the drawings. Note that terms indicating directions such as “top”, “bottom”, “left”, and “right” may be used below for convenience of description, but these terms are used in relation to the drawings and are not intended to limit the invention of the present application.

### 1. Basic Configuration of Film Packed Battery

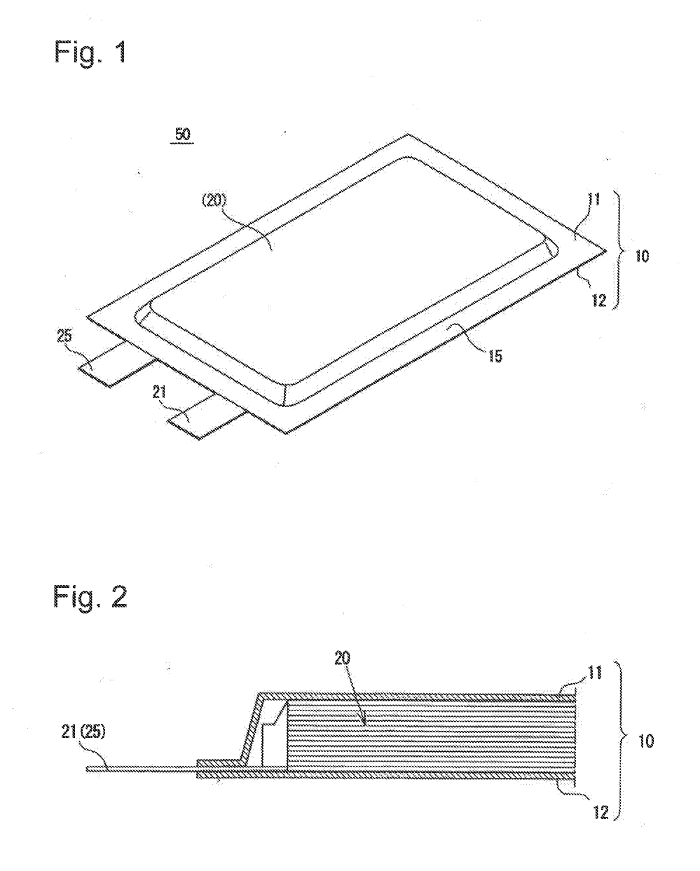

A basic configuration of a film packed battery will be described with reference to FIGS. 1 and 2. Note that an electrode tab is formed with a fusing part (fuse part) and is provided with a reinforcing member in the present example embodiment as will be described later, but the fusing part and the reinforcing member are omitted from FIGS. 1 and 2 for convenience of description.

As illustrated in FIGS. 1 and 2, a film packed battery 50 according to one mode of the present invention includes a battery element 20, a film housing 10 for housing the battery element 20, and a positive electrode tab 21 and a negative electrode tab 25 (hereinafter, these are also referred to simply as “electrode tabs”) that are connected to the battery element 20 and are led out to outside of the film housing 10.

The battery element 20 is layers in which a plurality of positive electrodes and a plurality of negative electrodes each made of a metal foil having both faces applied with electrode materials are alternately stacked with a separator interposed therebetween. The outer shape of the battery element 20 as a whole is, but is not particularly limited to, a flat, substantially rectangular parallelepiped in the example.

Although not illustrated in detail, a positive electrode and a negative electrode each have, at a part of the periphery thereof, a partially protruding extension part. The extension part of the positive electrode and the extension part of the negative electrode are alternately disposed by being shifted in position so as not to interfere with each other when the positive electrode and the negative electrode are stacked. The extension parts of all the negative electrodes are gathered into one and connected with the negative electrode tab, and similarly for the positive electrodes, the extension parts of all the positive electrodes are gathered into one and connected with the positive electrode tab. Connection between the electrode tab and the extension part may be performed by welding. Note that a part where the extension parts are thus gathered into one in a stacking direction is also referred to as a “current collector part” or the like.

The electrode tabs 21 and 25 to be connected to the current collector part may employ various types of materials, and one example of the material for the positive electrode tab 21 is aluminum or an aluminum alloy and one example of the material for the negative electrode tab 25 is copper or nickel. When the material of the negative electrode tab 25 is copper, a surface may be nickel plated.

For each of elements in the battery element, the following material may be specifically employed.

### <Separator>

The separator can use a web and a sheet made of an organic material, for example, a woven fabric such as cellulose, a nonwoven fabric, a porous polymer membrane such as a polyolefin-based membrane including polyethylene, polypropylene and the like, a polyimide membrane, and a porous polyvinylidene difluoride membrane, or an ion-conductive polymer electrolyte membrane. These materials can be used alone or in combination.

In addition, the separator can also use a separator made of an inorganic material such as ceramic and glass. Examples of the inorganic separator include: a nonwoven separator made of a ceramic short fiber such as alumina, alumina-silica, and potassium titanate; a separator composed of a base made of a woven fabric, a nonwoven fabric, paper or a porous film and a layer including a heat-resistant nitrogen-containing aromatic polymer and a ceramic powder; a porous thin film layer separator on a part of the surface of which a heat-resistant layer is disposed, the heat-resistant layer being made of a porous thin film layer containing a ceramic powder, a porous thin film layer of a heat-resistant resin, or a composite of a ceramic powder and a heat-resistant resin; a separator that includes a layer of a porous membrane obtained by sintering or binding through dissolution and recrystallization some of primary particles of a ceramic substance to give secondary particles, and binding the secondary particles with use of a binder; a separator that includes a base layer made of a polyolefin porous film and a heat-resistant insulation layer formed on one face or both faces of the base layer, the heat-resistant insulation layer including an oxidation-resistant ceramic particle and a heat-resistant resin; a separator that includes a porous membrane formed by binding a ceramic substance and a binder, the ceramic substance using silica (SiO₂), alumina (Al₂O₃), zirconium oxide (ZrO₂), titanium oxide (TiO₂), a nitride of silicon (Si), a hydroxide of aluminum (Al), an alkoxide of zirconium (Zr), and a ketone compound of titanium (Ti); or a separator that includes a polymer base and a coating layer formed on the polymer base and containing a ceramic of Al₂O₃, MgO, TiO₂, Al(OH)₃, Mg(OH)₂, and Ti(OH)₄.

### <Negative Electrode>

The negative electrode has a negative electrode current collector formed of a metal foil, and a negative electrode active material coated on both faces of the negative electrode current collector. The negative electrode active material is bound so as to cover the negative electrode current collector with a negative electrode binder material. The negative electrode current collector is formed to have an extension part for connecting to a negative electrode terminal, and the extension part is not coated with the negative electrode active material.

Examples of the negative electrode active material according to the present example embodiment include, but are not particularly limited to, a carbon material capable of adsorbing and desorbing a lithium ion, a metal capable of alloying with lithium, and a metal oxide capable of adsorbing and desorbing a lithium ion.

Examples of the carbon material include carbon, amorphous carbon, diamond-like carbon, a carbon nanotube, or a composite of these materials. Herein, the highly crystallizable carbon has high electrical conductivity, and has an excellent adhesive property and voltage flatness with a negative electrode current collector made of a metal such as copper. On the other hand, the less crystallizable amorphous carbon has relatively small volume expansion, and thus has a high effect of alleviating volume expansion of an entire negative electrode and is less susceptible to deterioration caused by unevenness such as a grain boundary and a defect.

A negative electrode containing a metal and a metal oxide is preferred in that energy density can be improved and capacity per unit weight or unit volume of a battery can be increased.

Examples of the metal include Al, Si, Pb, Sn, In, Bi, Ag, Ba, Ca, Hg, Pd, Pt, Te, Zn, La, or an alloy of two or more of these metals. In addition, two or more of these metals or the alloy may be mixed for use. In addition, these metals or the alloy may contain one or more of nonmetal elements.

Examples of the metal oxide include a silicon oxide, an aluminum oxide, a tin oxide, an indium oxide, a zinc oxide, a lithium oxide, or a composite of these oxides. In the present example embodiment, a tin oxide or a silicon oxide is preferably contained as the negative electrode active material, and more preferably, a silicon oxide is contained. This is because the silicon oxide is relatively stable and is less likely to cause a reaction with another compound. In addition, the metal oxide can be also added with, for example, 0.1 to 5% by mass of one or more of elements selected from nitrogen, boron and sulfur. This can improve electrical conductivity of the metal oxide. In addition, coating the metal and the metal oxide with a conductive substance such as carbon by using a method, for example, vapor deposition can also improve the electrical conductivity in the same way.

In addition, the negative electrode active material can also use a plurality of mixed materials, rather than using a single material. For example, materials of an identical type, such as graphite and amorphous carbon, may be mixed, and materials of different types, such as graphite and silicon, may be mixed.

The negative electrode binder agent can use, but is not particularly limited to, a polyvinylidene difluoride, a vinylidene fluoride-hexafluoropropylene copolymer, a vinylidene fluoride-tetrafluoroethylene copolymer, a styrene-butadiene copolymer rubber, a polytetrafluoroethylene, a polypropylene, a polyethylene, a polyimide, a polyamide-imide, and a polyacrylic acid, for example. The negative electrode binder agent is preferably used in an amount of 0.5 to 25 parts by mass relative to 100 parts by mass of the negative electrode active material, in terms of “sufficient binding force” and “higher energy” in a trade-off relationship.

The negative electrode current collector is preferably aluminum, nickel, stainless steel, chromium, copper, silver, and an alloy thereof, in view of electrochemical stability. Examples of the shape of the negative electrode current collector include a foil, a flat plate-like shape, and a mesh-like shape.

A coating layer including the negative electrode active material may be added with a conductive assistant for the purpose of reducing impedance. Examples of the conductive assistant include squamous, soot-like, fibrous carbonaceous microparticles, such as graphite, carbon black, acetylene black, and vapor grown carbon fiber (VGCF (Registered Trademark) manufactured by Showa Denko KK).

### <Positive Electrode>

The positive electrode has a positive electrode current collector formed of a metal foil, and a positive electrode active material coated on both faces of the positive electrode current collector. The positive electrode active material is bound so as to cover the positive electrode current collector with a positive electrode binder agent. The positive electrode current collector is formed to have an extension part for connecting to a positive electrode terminal, and the extension part is not coated with the positive electrode active material.

The positive electrode active material according to the present example embodiment is not particularly limited as long as the positive electrode active material is a material capable of adsorbing and desorbing lithium, and can be selected in terms of several viewpoints. In terms of higher energy density, a high-capacity compound is preferably contained. Examples of the high-capacity compound include a lithium nickelate (LiNiO₂) or a lithium nickel composite oxide in which some of Ni in a lithium nickelate are substituted by another metal element, and a laminar lithium nickel composite oxide represented by Formula (A) below is preferred.

Li_{y}Ni₍₁₋ₓ₎MₓO₂ (A)

(where 0≦x<1, 0<y≦1.2, and M is at least one element selected from a group consisting of Co, Al, Mn, Fe, Ti and B.)

In view of a higher capacity, Ni is preferably contained in a high amount, in other words, x in Formula (A) is preferably less than 0.5, and more preferably, equal to or less than 0.4. Examples of such a compound include Li_{α}Ni_{β}Co_{γ}Mn_{δ}O₂ (0≦α≦1.2, preferably, 1≦α≦1.2, β+γ+δ=1, β≧0.7, γ≦0.2), Li_{α}Ni_{β}Co_{γ}Al_{δ}O₂ (0≦α≦1.2, preferably, 1≦α≦1.2, β+γ+δ=1, β≧0.6, preferably, β≧0.7, γ≦0.2), and particularly, LiNi_{β}Co_{γ}Mn_{δ}O₂ (0.75≦β≦0.85, 0.05≦γ≦0.15, 0.10≦δ≦0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ can be preferably used.

In addition, in terms of thermal stability, Ni is preferably contained in an amount not exceeding 0.5, in other words, x in Formula (A) is preferably equal to or more than 0.5. In addition, a particular transition metal is preferably contained within a range not exceeding half in number. Examples of such a compound include Li_{α}Ni_{β}Co_{γ}Mn_{δ}O₂ (0≦α≦1.2, preferably, 1≦α≦1.2, β+γ+δ=1, 0.2≦β≦0.5, 0.1≦γ≦0.4, 0.1≦δ≦0.4). More specifically, examples include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (however, variations of these compounds in which the contents of the respective transition metals are varied by about 10% are also included).

In addition, two or more of compounds represented by Formula (A) may be mixed for use, and, for example, NCM532 or NCM523 and NCM433 are preferably mixed for use within a range from 9:1 to 1:9 (as a typical example, 2:1). Further, by mixing a material of a high Ni content in Formula (A) (x is equal to or less than 0.4) with a material of a Ni content not exceeding 0.5 in Formula (A) (x is equal to or more than 0.5, for example, NCM433), a high-capacity battery having high thermal stability can be configured.

Examples other than the above of the positive electrode active material include: a lithium manganese oxide with a laminar structure or a spinel structure such as LiMnO₂, LiₓMn₂O₄ (0<x<2), Li₂MnO₃, and LiₓMn_{1.5}Ni_{0.5}O₄ (0<x<2); a material in which some of LiCoO₂ or transition metals thereof are substituted by another metal; a material in which these lithium transition metal oxides contain a larger amount of Li than the stoichiometric composition; and a material that has an olivine structure such as LiFePO₄. Further, a material in which some of these metal oxides are substituted by Al, Fe, P, Ti, Si, Pb, Sn, In, Bi, Ag, Ba, Ca, Hg, Pd, Pt, Te, Zn, La, and the like can be also used. Any one of the above-described positive electrode active materials can be used alone, or any two or more thereof can be used in combination.

In addition, a radical material and the like can be used as the positive electrode active material.

The positive electrode binder agent can use a material equivalent to that of the negative electrode binder agent. The positive electrode binder agent is preferably used in an amount of 2 to 15 parts by mass relative to 100 parts by mass of the positive electrode active material, in terms of “sufficient binding force” and “higher energy” in a trade-off relationship.

The positive electrode current collector can use a material equivalent to that of the negative electrode current collector.

A coating layer of the positive electrode active material may be added with a conductive assistant for the purpose of reducing impedance. Examples of the conductive assistant include a carbonaceous microparticle such as graphite, carbon black, and acetylene black.

### <Electrolyte Solution>

The electrolyte solution used in the present example embodiment can use a nonaqueous electrolyte solution containing a lithium salt (supporting salt) and a nonaqueous solvent dissolving the supporting salt.

The nonaqueous solvent can use an aprotic organic solvent such as a carbonate ester (chain or cyclic carbonate), a carboxylate ester (chain or cyclic carboxylate ester), and a phosphate ester.

Examples of the carbonate ester solvent include: cyclic carbonates such as propylene carbonate (PC), ethylene carbonate (EC), butylene carbonate (BC), and vinylene carbonate (VC); chain carbonates such as dimethyl carbonate (DMC), diethyl carbonate (DEC), ethyl methyl carbonate (EMC), and dipropyl carbonate (DPC); and a propylene carbonate derivative.

Examples of the carboxylate ester solvent include: aliphatic carboxylate esters such as methyl formate, methyl acetate, and ethyl propionate; and lactones such as γ-butyrolactone.

Among the above, the carbonate ester (cyclic or chain carbonates) such as ethylene carbonate (EC), propylene carbonate (PC), butylene carbonate (BC), vinylene carbonate (VC), dimethyl carbonate (DMC), diethyl carbonate (DEC), ethyl methyl carbonate (MEC), and dipropyl carbonate (DPC) is preferred.

Examples of the phosphate ester include trimethyl phosphate, triethyl phosphate, tripropyl phosphate, trioctyl phosphate, and triphenyl phosphate.

In addition, examples of the solvent other than the above that can be contained in the nonaqueous electrolyte solution include: aliphatic carboxylate esters such as ethylene sulfite (ES), propanesultone (PS), butanesultone (BS), dioxathiolane-2,2-dioxide (DD), sulfolene, 3-methyl sulfolene, sulfolane (SL), succinic anhydride (SUCAH), propionic anhydride, acetic anhydride, maleic anhydride, diallyl carbonate (DAC), dimethyl 2,5-dioxahexanedioate, dimethyl 2,5-dioxahexanedioate, furan, 2,5-dimethylfuran, diphenyl disulfide (DPS), dimethoxyethane (DME), dimethoxymethane (DMM), diethoxyethane (DEE), ethoxymethoxyethane, chloroethylene carbonate, dimethyl ether, methyl ethyl ether, methyl propyl ether, ethyl propyl ether, dipropyl ether, methyl butyl ether, diethyl ether, phenyl methyl ether, tetrahydrofuran (THF), 2-methyltetrahydrofuran (2-MeTHF), tetrahydropyran (THP), 1,4-dioxane (DIOX), 1,3-dioxolane (DOL), methyl acetate, ethyl acetate, propyl acetate, isopropyl acetate, butyl acetate, methyl difluoroacetate, methyl propionate, ethyl propionate, propyl propionate, methyl formate, ethyl formate, ethyl butyrate, isopropyl butyrate, methyl isobutyrate, methyl cyanoacetate, vinyl acetate, diphenyl disulfide, dimethyl sulfide, diethyl sulfide, adiponitrile, valeronitrile, glutaronitrile, malononitrile, succinonitrile, pimelonitrile, suberonitrile, isobutyronitrile, biphenyl, thiophene, methyl ethyl ketone, fluorobenzene, hexafluorobenzene, a carbonate electrolyte solution, a glyme, an ether, acetonitrile, propionitrile, γ-butyrolactone, γ-valerolactone, a dimethyl sulfoxide (DMSO) ionic liquid, phosphazene, methyl formate, methyl acetate, and ethyl propionate; or a substance in which some of hydrogen atoms in these compounds are substituted by fluorine atoms.

The supporting salt according to the present example embodiment can use a lithium salt that is usable in a normal lithium ion battery, such as LiPF₆, LiAsF₆, LiAlCl₄, LiClO₄, LiBF₄, LiSbF₆, LiCF₃SO₃, LiC₄F₉SO₃, LiC(CF₃SO₂)₃, and LiN(CF₃SO₂)₂. The supporting salt can be used alone, or two or more of the supporting salts can be used in combination.

The nonaqueous solvent can be used alone, or two or more of the nonaqueous solvents can be used in combination.

### <Housing>

The housing can be selected as appropriate as long as the housing is stable in the electrolyte solution and has a sufficient water vapor barrier property. For example, in a case of a stacked laminate secondary battery, the housing preferably uses a laminated film of aluminum and a resin. The housing may be configured with a single member, or may be configured with a plurality of members in combination.

In the present example embodiment, as illustrated in FIG. 1, the film housing 10 may be configured with a first film 11 and a second film 12 disposed facing the first film 11. The contour shape of the film housing 10 may be, but is not particularly limited to, quadrilateral, and is rectangle in the example. The films 11 and 12 are thermally welded and bonded to each other around the battery element 20. Thus, the periphery of the film housing 10 is a thermal welding part 15. The positive electrode tab 21 and the negative electrode tab 25 are led out from one of short sides of the thermal welding part 15.

Note that, regarding a lead-out position of the electrode tabs 21 and 25, the tabs may be led out from one of long sides. In addition, the positive electrode tab 21 and the negative electrode tab 25 may be led out from different sides. Examples of this include a configuration in which the positive electrode tab 21 and the negative electrode tab 25 are led out from opposite sides in directions opposite from each other.

### 2. Specific Configurations of Electrode Tab and the Like

### <Fusing Part>

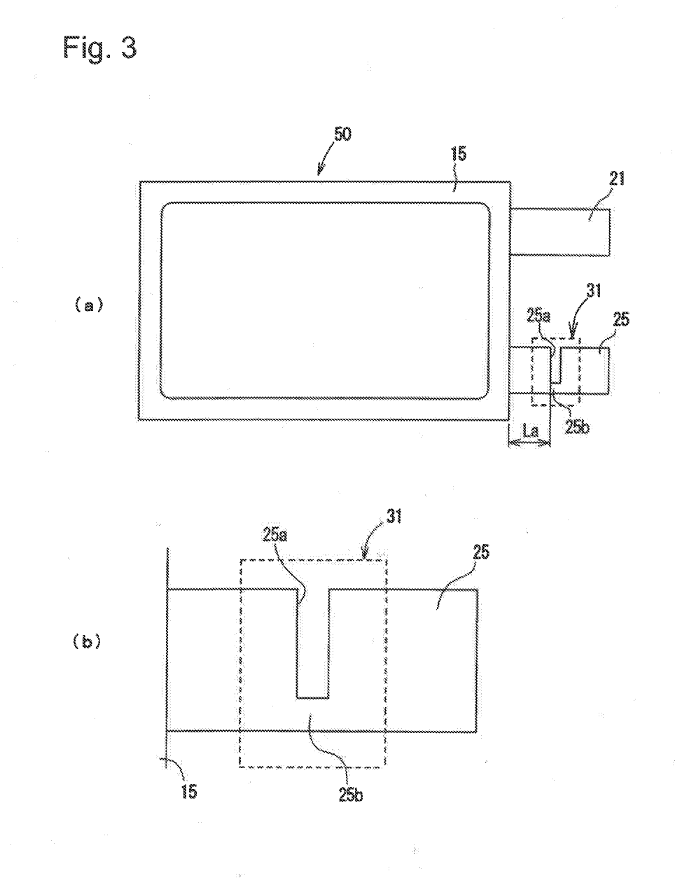

In one mode of the present invention, as schematically illustrated in FIG. 3, a part of the negative electrode tab 25 is formed with a fusing part (fuse part) 25b that rises to a high temperature and preferentially ruptures rather than another region when a predetermined current flows. Note that the following describes an example in which the fusing part 25b is formed on the negative electrode tab 25, but the fusing part may be provided on the positive electrode tab 21. In addition, in the following description, the “negative electrode tab 25” will be referred basically to as the “electrode tab 25”.

As illustrated in FIG. 3 (b), the fusing part 25b is a part formed to have a cross-sectional area smaller than another region of the electrode tab 25. By being formed to have a small cross-sectional area, the part locally has a large current density and generates heat, and when the temperature exceeds a melting point of the material, the part melts to fuse.

The fusing part 25b may have any specific shape as long as functioning as described above. In the example of FIG. 3, by providing a slit 25a extending in a width direction of the electrode tab 25, a remaining part of the electrode tab 25 is formed as the fusing part 25b. The fusing part 25b as described above is advantageous in the point that fabrication is easy.

As another aspect, the slit 25a, which is elongated rectangle in the example, may have curved corners on the leading end side of the slit (corners on the lower side in the drawing). This alleviates stress concentration in the vicinity of the fusing part 25b, and the fusing part 25b becomes less susceptible to rupture or the like even when a force is applied to the electrode tab 25 for some reason. As a different aspect, the slit may be a wedge shape. A wedge-shaped leading end may be a sharp corner, or may be a curved corner. In FIG. 3, only one slit is formed on the tab, but two slits (respectively extending from ends of the tab toward the center side) may be formed and a remaining region between the slits may be formed as a fusing part. Note that still another example of the fusing part, the slit, or the like will be described later with reference to a different drawing as well.

### <Reinforcing Member>

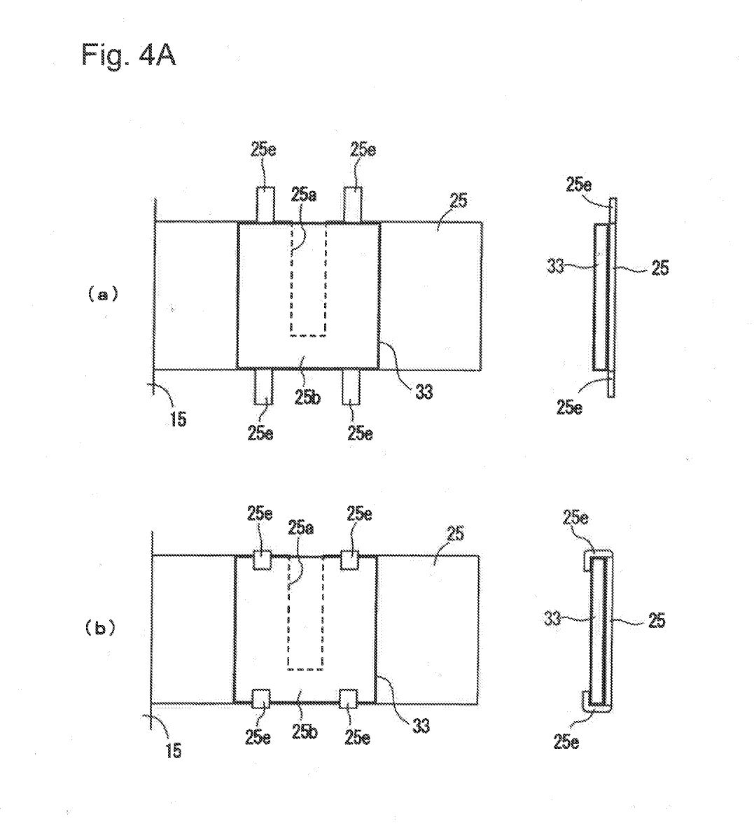

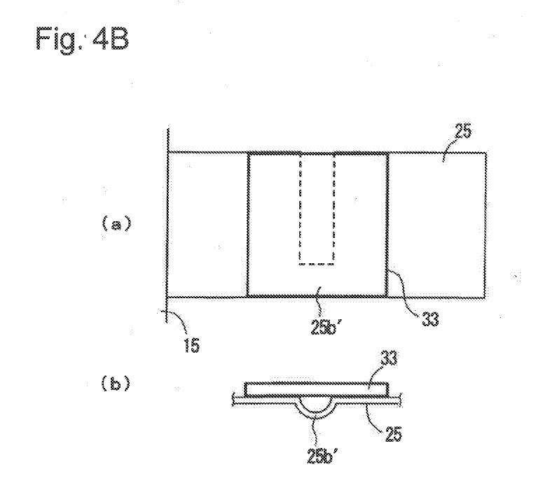

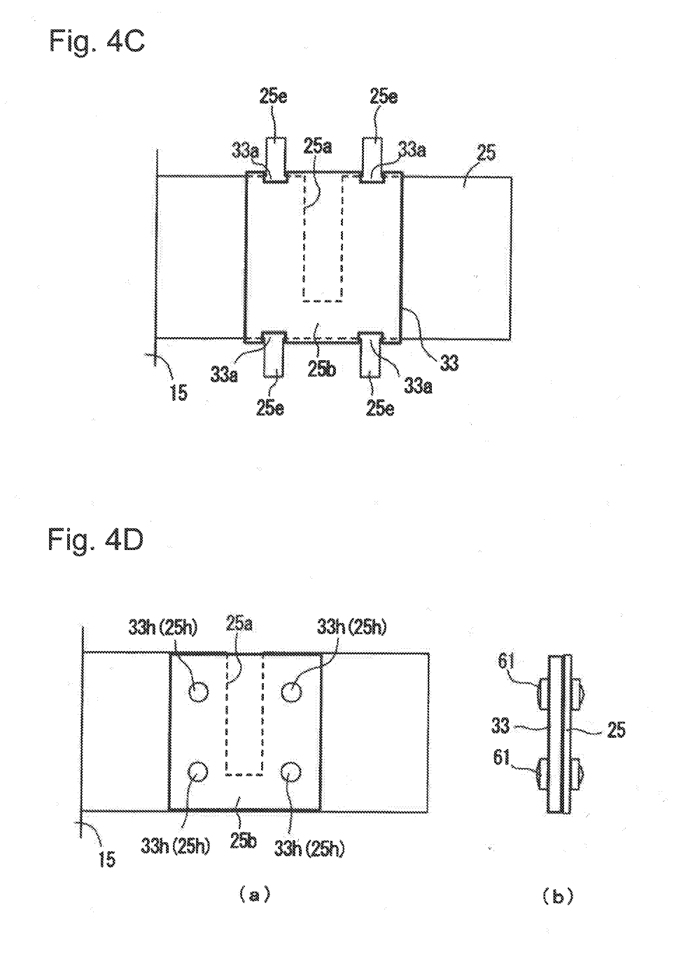

The electrode tab 25 is provided with a reinforcing member 31 at a section including at least the fusing part 25b. The reinforcing member 31 is attached to the electrode tab 25 and serves a role for reinforcing mechanical strength of the tab. As described above, the fusing part 25b is a part formed to have a cross-sectional area smaller than another region of the electrode tab 25 and is susceptible to rupture or damage when a force is applied to the tab for some reason. However, by providing the reinforcing member 31 as in the present example embodiment, the electrode tab 25 is reinforced, and rupture or damage is prevented. The reinforcing member 31 is abstractly illustrated in FIG. 3, but may be more specifically configured as in FIG. 4A.

In the configuration of FIG. 4A, a reinforcing member 33 is disposed on one face of the electrode tab 25. The reinforcing member 33 is a plate-like member as an example. The reinforcing member 33 may not be necessarily a flat plate-like member, but may be, for example, a curved plate-like member or a rugged plate-like member. However, a flat plate-like member is advantageous in terms of easy fabrication and inexpensive manufacturing cost. The contour shape of the reinforcing member 33 may be, but not limited to, rectangle.

A principal face of the reinforcing member 33 and a principal face of the electrode tab 25 may be in contact with each other, or may be configured to be approximate to but not in contact with each other. Another member may be interposed between the reinforcing member 35 and the electrode tab 25.

As illustrated in FIG. 4A (a) and (b), the reinforcing member 33 is disposed so as to cover the notch part 25a of the electrode tab 25. On both sides in a width direction (a top-bottom direction in the drawing) of the electrode tab 25, a plurality of locking pieces 25e are formed, and each of the locking pieces 25e extends outward in the width direction of the tab. More specifically, four in total of the locking pieces 25e are formed. By bending the locking pieces 25e and locking the locking pieces 25e at peripheral edges of the reinforcing member 33 as illustrated in FIG. 4A (b), the reinforcing member 33 is secured.

As the reinforcing member 33 is for reinforcing the electrode tab 25, the member preferably has relatively high rigidity. A metal material, a resin material, a ceramic material, or a composite material thereof can be basically used. Materials obtained by coating these materials with a coating film or plating are also preferred.

In one mode, a material for use in the reinforcing member preferably has a high insulation property, a high thermal insulation property, and a high heat resistance property. Regarding the electrical insulation property, for example, a material having a volume resistivity of 1×10¹ (Ω·m) or more can be used. Regarding the thermal insulation property, for example, a material having a thermal conductivity of 8 W·m⁻¹·K⁻¹ or less can be used. Regarding the heat resistance property, a material having a temperature at which a material undergoes deformation and degradation, such as a melting point (softening point) and a pyrolysis temperature, of 150° C. or more (a polyolefin such as PP, a phenolic resin, and the like), preferably 200° C. or more (a silicon resin, cellulose, and the like), more preferably 250° C. or more (an epoxy resin, a fluorine resin, and the like), and still more preferably 300° C. or more (a polyimide class, an inorganic material such as glass, and the like) can be used.

Note that when the reinforcing member 33 is, for example, a conductive material, current flows through the member and the fusing part 25b does not serve a role as a fuse. Thus, although the reinforcing member 33 itself may be a conductive material, the reinforcing member 33 needs to be electrically insulated from the electrode tab 25 in the case.

A material of the reinforcing member 33 may use a heat-resistant insulation material. For example, the material may be a ceramic, and can use alumina, glass, aluminum nitride (AlN), zirconia, silicon nitride (Si₃N₄), and the like. In addition, the material is preferably a flame-retardant resin, and can use a polyimide resin, an epoxy resin, a phenolic resin, and the like. Such a resin preferably has a flame-retardant property at a degree such that the resin does not melt even when the fusing part 25b fuses.

The reinforcing member 33 is preferably a material having a low thermal conductivity (a thermal insulation material), basically. This prevents heat from the fusing part 25b from leaking outside, so that the part effectively fuses. However, as will be described below, the reinforcing member 33 may be a material having a relatively high thermal conductivity.

When focusing on that the reinforcing member 33 is in contact with one face of the electrode tab 25 (although not required), the reinforcing member 33 may also function as a heat dissipation member for the electrode tab 25. Thus, in order to ensure a heat dissipation performance from the electrode tab 25, the reinforcing member 33 may be a material having a relatively high thermal conductivity. In this case, for example, the reinforcing member 33 may be a metallic member applied with a ceramic coating, an alumite process (anodizing process), a heat-resistant resin coating, and the like.

Such a configuration may be a configuration in which, as illustrated in FIG. 4B, the fusing part 25b′ and the reinforcing member 33 make no contact with each other, in other words, a space is provided between the fusing part 25b′ and the reinforcing member 33. In the example, the electrode tab 25 is configured to be partially curved at the fusing part 25b′ (see FIG. 4B (b)) so that there is no contact at the fusing part 25b′ and the electrode tab 25 and the reinforcing member 33 make contact with each other on both sides of the fusing part 25b′. According to such a configuration, while the reinforcing member 33 is used as a heat dissipation member, the fusing part 25b′ can favorably maintain a function as a fusing part since heat of the fusing part 25b′ is not dissipated through the reinforcing member 33.

In the above, the material and the like of the reinforcing member 33 have been described using the reinforcing member 33 as an example. However, a person skilled in the art should understand that the above description is not limited to the reinforcing member 33 of FIG. 4A, but is common in reinforcing members illustrated in other drawings and other reinforcing members described without illustration.

Regarding the insulation property, the thermal insulation property, and the heat resistance property of the reinforcing member, instead of using the reinforcing member having a high insulation property, a high thermal insulation property and/or a high heat resistance property, connection between the tab and the reinforcing member may be performed by interposing a material having such properties between the tab and the reinforcing member.

When securing the reinforcing member 33 by using the locking pieces 25e of the electrode tab 25 as in FIG. 4A, recesses 33a may be formed on the reinforcing member 33 as in FIG. 4C in order to more accurately secure the reinforcing member 33 in position. The recesses 33a are formed at positions corresponding to the respective locking piece 25e, and are formed to have a width wider than that of the locking pieces 25e.

As the fusing part 25b is a part that rises to a high temperature and fuses, in order to prevent the heat from propagating through the electrode tab 25 and melting a part of the film housing 10, a predetermined distance or more is preferably left between the fusing part 25b and the film housing 10 (more specifically, a distance La from an edge of the thermal welding part 15 of the films, see FIG. 3 (a)). As an example, the distance La preferably ranges from 5 mm to 30 mm, and more preferably ranges from 10 mm to 20 mm. A too short distance La may cause an influence of heat generation to reach the thermal welding part of the films, whereas a too long distance La may lead to a larger battery size.

The “predetermined distance” is preferably, for example, a distance that is set in such a manner that a temperature of the electrode tab 25 at the thermal welding part 15 does not go above a melting point of a material of the welding part of the film housing 10 at a point of time when the fusing part 25b fuses.

According to the configuration as described above, since the reinforcing member 33 is attached to the vicinity of the fusing part 25b and thus the electrode tab 25 is reinforced, the electrode tab 25 (particularly, the fusing part 25b) is prevented from rupture or breakage even when an unexpected force is applied to the electrode tab 25 and the like. In addition, according to the configuration as in the present example embodiment in which a member (thermal insulation material) is disposed approximate to the fusing part 25b, the fusing part 25b can fuse effectively in comparison with a configuration without such a member.

According to a method in which the locking pieces 25e formed on the electrode tab 25 are bent to secure the reinforcing member 33 as has been illustrated in FIGS. 4A and 4C, the configuration is simple and the attaching work is facilitated.

The invention is not limited to the above, but can be modified in various ways. Some of other aspects of the present invention will be described below while showing examples in the drawings. It is needless to say that the technical matters disclosed herein as individual aspects can be mutually combined within the scope not departing from the gist of the present invention.

### (Mechanical Coupling)

The reinforcing member 33 may be secured to the electrode tab 25 by means of fixtures 61 as illustrated in FIG. 4D. The fixtures 61 can use screws (bolts), rivets, clips, grommets, fasteners (securing means), and the like. The fixtures 61 may be insulative. In addition, the fixtures 61 are preferably heat resistant and/or thermally insulative. The fixtures 61 can be also configured with a material equivalent to that of the reinforcing member.

In the example, the electrode tab 25 and the reinforcing member 33 are formed with through holes 25h and 35h, through which bolts are inserted and secured by nuts. As can be seen from FIG. 4D (a), portions on both sides of the slit 25a of the electrode tab 25 are preferably secured by the fixtures 61. Note that two through holes 33h and 25h are formed on each of right and left sides of the slit 25a in the example, but only one through hole or three or more through holes may be formed.

Although not illustrated in detail, the electrode tab 25 may be sandwiched by two reinforcing members of a reinforcing member 33 and another reinforcing member (not illustrated) disposed on another face side across the electrode tab 25. In other words, a first reinforcing member 33 and a second reinforcing member (not illustrated) are configured to sandwich the electrode tab for reinforcement. In this case, both of the reinforcing members may be tightly attached to the electrode tab 25, or alternatively, a predetermined clearance (with a dimension larger than a thickness of the electrode tab) may be formed between the two reinforcing members by interposing, for example, a spacer (not illustrated).

### (Another Example of Reinforcing Member)

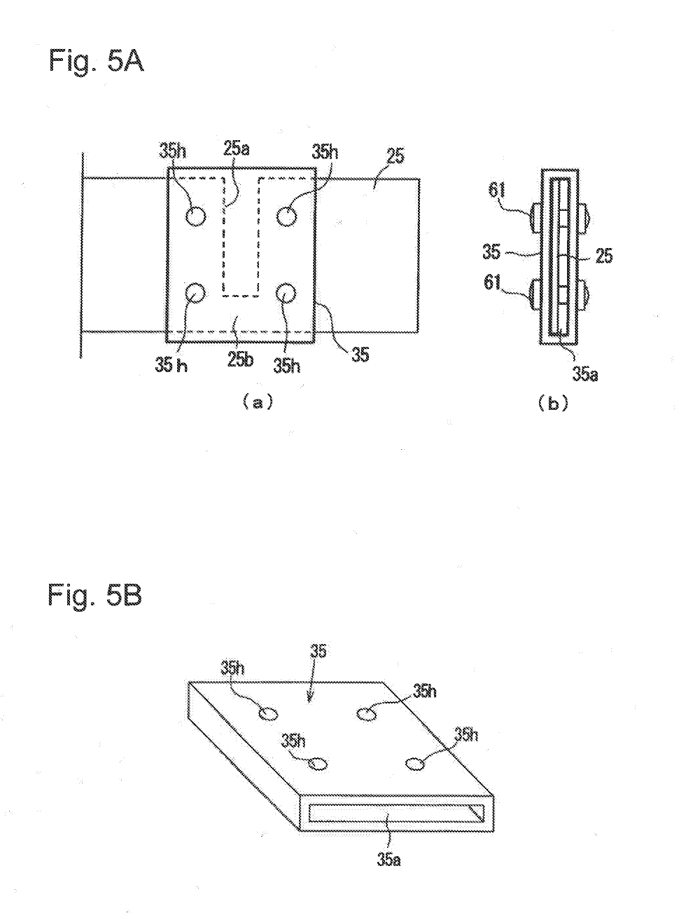

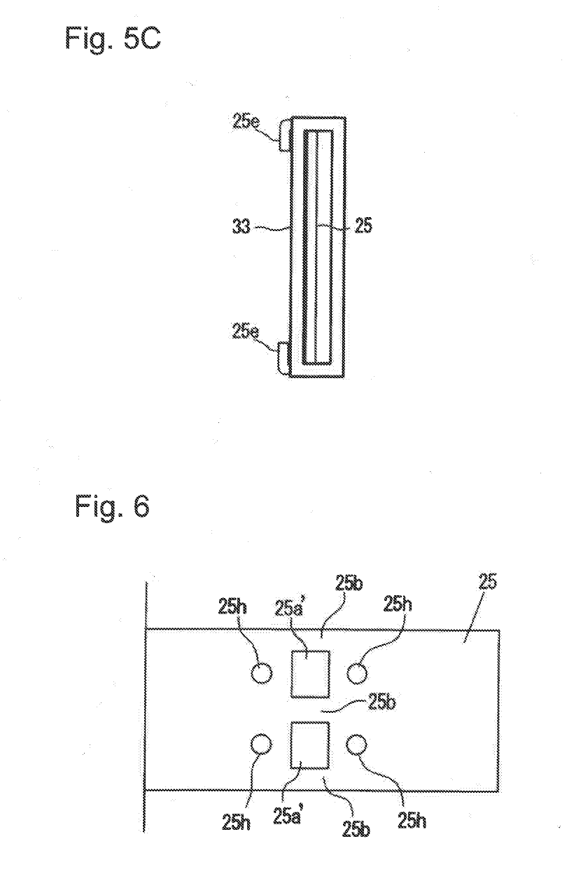

As illustrated in, for example, FIGS. 5A and 5B, the reinforcing member may be such a hollow member that surrounds the electrode tab 25. A reinforcing member 35 is a flat hollow member having a rectangular cross-section in an example, and the electrode tab 25 is inserted through an internal space 35a of the reinforcing member 35.

Securing between the reinforcing member 35 and the electrode tab 25 may be performed by using the fixtures 61 such as screws as in FIG. 4D. In this case, the through holes 35h for passing the screws or the like are formed on the reinforcing member 35.

The reinforcing member 35 may be configured as a single member, or may be configured by combining a plurality of components. For example, the reinforcing member 35 may be composed of two components of a top face-side component and a bottom face-side component. The reinforcing member 35 and/or the components constituting the reinforcing member 35 can use a material equivalent to that described in relation to the above reinforcing member 33.

FIGS. 5A and 5B illustrate the reinforcing member 35 and the electrode tab secured by using the fixtures 61 such as screws, and besides this, as illustrated in FIG. 5C, securing may be performed by the locking pieces 25e of the electrode tab 25 (also see FIG. 4A) being locked at respective parts of the reinforcing member 35.

### (Another Example of Fusing Part)

The above example embodiment has described the fusing part 25b provided with the slit 25a extending from a lateral end of the electrode tab 25. However, as illustrated in FIG. 6, the electrode tab 25 may be configured to include openings 25a′ and remaining parts function as the fusing parts 25b. Two openings 25a′ are formed in the example, but one elongated opening may be formed. According to the configuration, because of the plurality of fusing parts, rupture or breakage is less likely to occur even when an unexpected force is applied, in comparison with a case of leaving only a part of the electrode tab for a fusing part.

As a matter of course, two or more fusing parts 25b may be formed by combining the opening 25a′ and the slit 25a (see FIG. 4A).

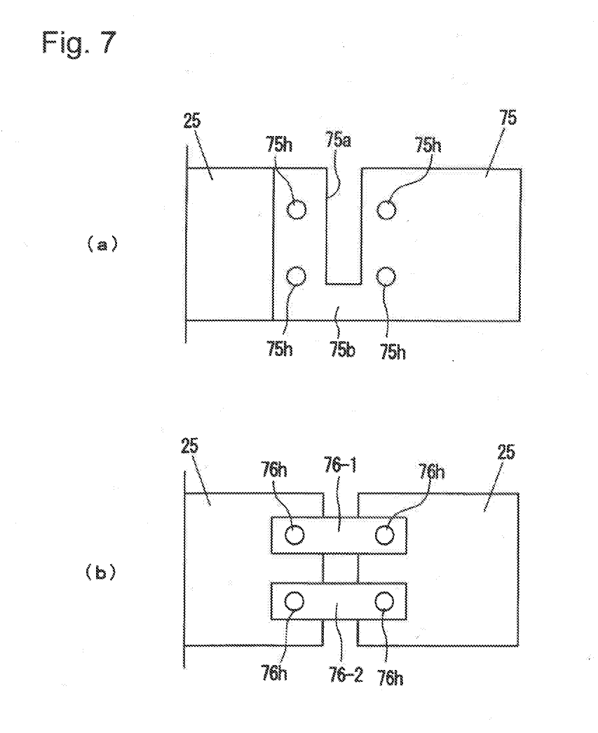

The above example embodiment has described the fusing part 25b formed on the electrode tab 25 itself. However, as illustrated in FIG. 7, a fusing part 75b may be formed on another conducting material 75 connected to the electrode tab 25. Note that the shape and the like of the fusing part 75b can be directly applied with the technical matters described above, and repeated description will be omitted.

The electrode tab 25, which is to be partially enclosed in the film housing 10, has a constraint on a material. In contrast, according to the configuration as in FIG. 7, a more preferable material can be selected regarding a fuse function. A material of the conducting material 75 may be, for example, a material for a fuse, and can specifically use Al, Ag, Sn, Pb, Bi, Sb, In, Cd, Zn, an alloy thereof, and the like.

In FIG. 7 (a), the electrode tab 25 is connected with the conducting material 75 having a material different from that of the electrode tab 25, and the fusing part 75b is formed by forming a slit 75a on a part of the conducting material 75 as an example.

Even in such a configuration, a reinforcing member (illustration omitted) is preferably attached to an area including the fusing part 75b and the conducting material 75 is mechanically reinforced by the reinforcing member. In the example, four through holes 75h are all formed on the conducting material 75, but depending on the shapes of the conducting material 75 and the slit 75a and the positional relationship therebetween, some of the through holes may be formed on the electrode tab 25.

In FIG. 7 (b), the electrode tab 25 is configured to be cut into two of a proximal end side and a distal end side, and two narrow-width fuse members 76-1 and 76-2 connect between the two electrode tabs 25. Bonding between the electrode tab 25 and the fuse members 76-1 and 76-2 can employ, for example, resistance welding, ultrasonic welding, laser welding, caulking, and adhesion by means of a conductive adhesive agent.

The two fuse members 76-1 and 76-2 are used as an example, but only one of the fuse members 76-1 and 76-2 may suffice. Through holes for connecting the reinforcing member may be formed on both the conductive member and the electrode tab (see signs 76h in the drawing). Fixtures (for example, screws and grommets) for fixing the fuse members 76-1 and 76-2 can also use conductive fixtures.

### (Regarding Manufacturing Method)

In the above, the several modes of the present invention have been described for a film packed battery as a subject. However, the present invention can be also regarded as a method of manufacturing a battery. In other words, a method of manufacturing a battery according to one mode of the present invention includes the following steps of: preparing a battery element; enclosing the battery element and an electrolyte solution in a housing; forming, on a part of an electrode tab, a fusing part that preferentially fuses rather than another region when a predetermined current flows; and attaching a reinforcing member to the electrode tab at a section including at least the fusing part in a state that the reinforcing member is distant from the housing.

In the step of forming a fusing part, for example, a slit may be formed on an electrode tab by pressing or the like. The formation of a slit may be performed simultaneously in, for example, a step of cutting out or punching an electrode tab from a base material.

The step of providing a reinforcing member may be carried out after the electrode tab 25 is sandwiched by the thermal welding part 15 of the film housing 10, or may be performed with another timing. For example, the electrode tab 25 attached in advance with the reinforcing member 33 may be sub-assembled, and thereafter a part of the sub-assembled electrode tab 25 may be thermally welded in a state to sandwich the thermal welding part 15 of the film housing 10.

<Regarding Invention Other than Battery>

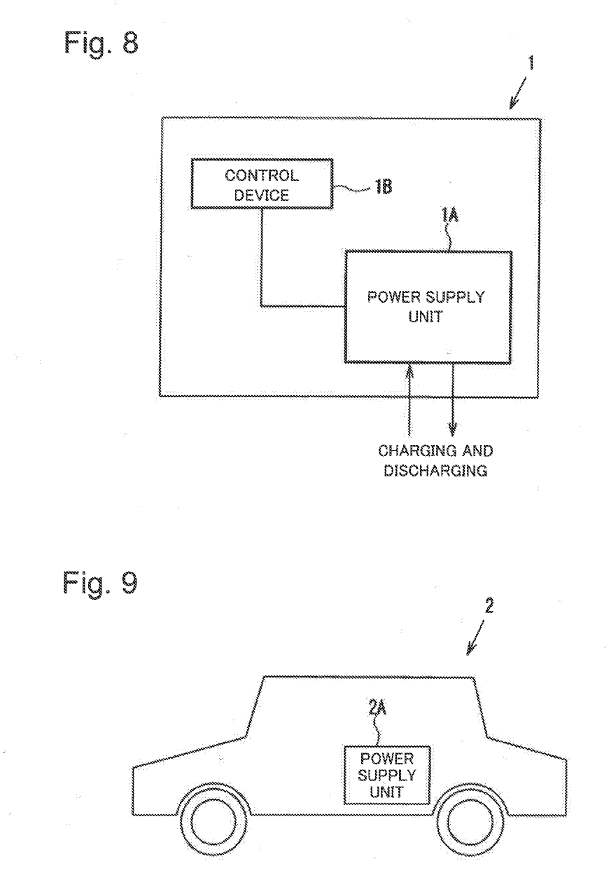

FIG. 8 is a schematic view of a power storage system using a secondary battery according to one mode of the present invention. A power storage system 1, which is not particularly limited to a large scale or a small scale, includes a power supply unit 1A that has at least one secondary battery (for example, the film packed battery 50), and a control device 1B that performs monitoring, control, and the like of charging and discharging of the power supply unit 1A. The power storage system 1 as described above may be, for example, a backup power supply, and can be of various types, such as for large facility use, for business use, and for household use.

FIG. 9 is a schematic view of an electric vehicle using a secondary battery according to one mode of the present invention. An electric vehicle 2 includes a power supply unit 2A that has at least one secondary battery (for example, the film packed battery 50), and a control device (not illustrated) that performs monitoring, control, and the like of charging and discharging of the power supply unit 2A.

### INDUSTRIAL APPLICABILITY

The secondary battery according to one mode of the present invention can be used in, for example, every industrial field that requires a power supply. As an example, the secondary battery can be used as: a power supply of a mobile device such as a mobile phone and a laptop; a power supply of an electric vehicle such as an electric automobile, a hybrid car, an electric motorcycle, and an electrically assisted bicycle; a power supply of a medium for transportation such as an electric train, a satellite, and a submarine; and a power storage system for storing electricity.

### <Regarding Configuration Example of Power Supply Unit>

The power supply unit may be specifically an assembled battery as described below. Note that the following describes the “power supply unit 1A”, but it is needless to say that the power supply unit is not limited for a power storage system, but may be a vehicle-mounted power supply unit.

### (First Aspect)

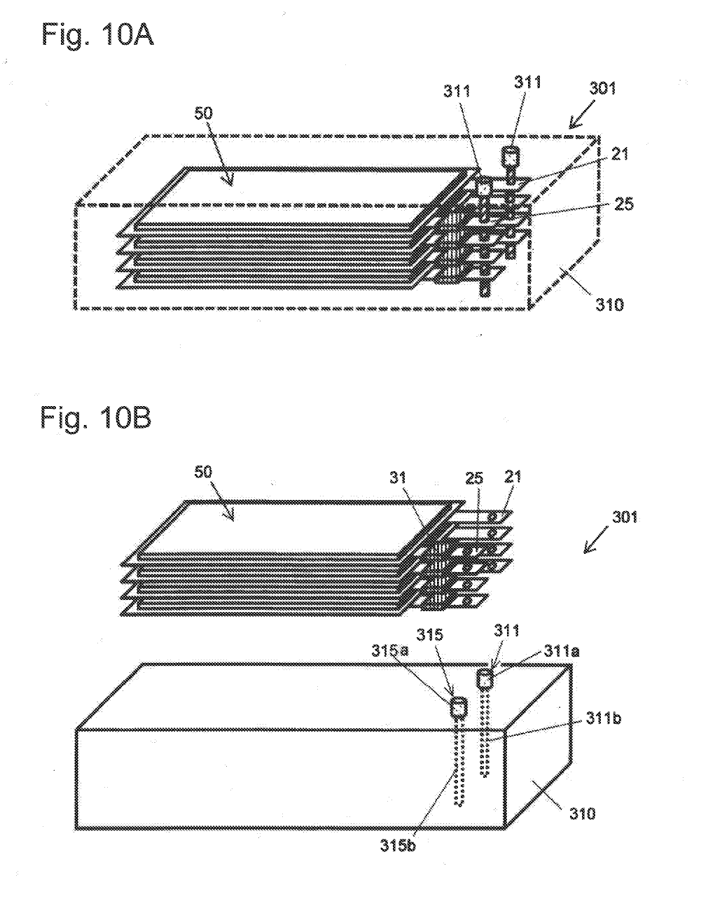

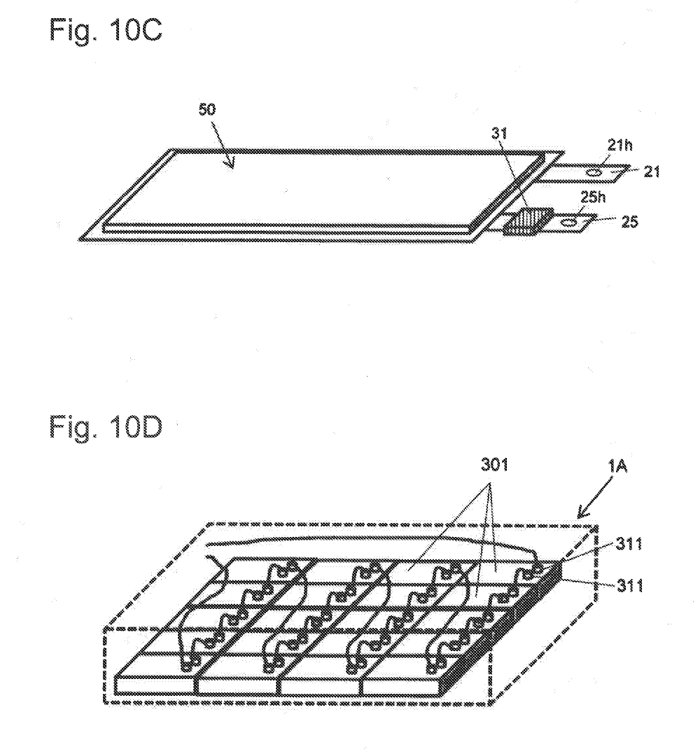

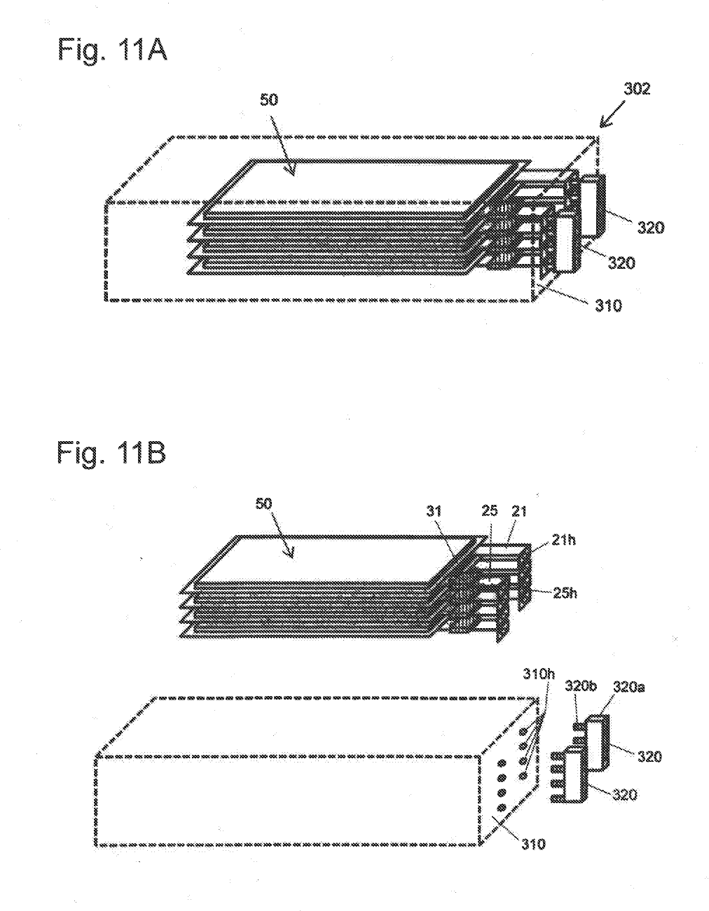

FIGS. 10A to 10D illustrate a first aspect. As illustrated in FIG. 10D, the power supply unit 1A includes a plurality of battery packs 301. In the example, the plurality of serially connected battery packs 301 are configured to output predetermined power as the power supply unit 1A.

As illustrated in FIGS. 10A and 10B, one of the battery packs 301 includes a plurality of film packed batteries 50, and a casing 310 that houses the plurality of film packed batteries 50. The casing 310 can use, but is not limited to, a resinous or metallic hard case, for example. As illustrated, the plurality of film packed battery 50 are piled up one on top of the other in a thickness direction and are incorporated in a stacked state. In the example, electrode tabs 21 and electrode tabs 25 of all the film packed batteries 50 are led out in the same direction.

As illustrated in FIG. 10C, an opening 21h and an opening 25h are formed on a part of the electrode tab 21 and a part of the electrode tab 25. As illustrated in FIGS. 10A and 10B, power takeoff terminal members 311 and 315 are respectively passed through the openings 21h and 25h. The terminal member 311 is a conductive material, and includes, as an example, an electrically connecting part 311b that is a part to be passed through the opening 21h, and a terminal part 311a formed at an end of the electrically connecting part 311b. Similarly, the terminal member 315 includes an electrically connecting part 315b and a terminal part 315a. The electrically connecting parts 311b and 315b each are formed into a bar shape as a whole, and may have a threaded part formed on the outer periphery.

In the present mode, when the plurality of film packed batteries 50 are piled up one on top of the other, openings 21h and openings 25h on the electrode tabs 21 and the electrode tabs 25 of the respective batteries are aligned each in a row in a stacking direction, through which the bar-shaped electrically connecting parts 311b and 315b are respectively passed. Accordingly, the positive electrode tabs 21 and the negative electrode tabs 25 are electrically connected to one other, respectively.

Note that in order for the electrode tab and the terminal member to make contact with each other more accurately (thus, for more accurate electrical connection), another not-illustrated fixture is preferably used in combination to cause the electrode tab and the terminal member to make firm contact with each other.

As described above, the terminal members 311 and 315 are electrically connected to the electrode tabs and function as terminals for power takeoff. However, at the same time, the terminal members 311 and 315 may physically hold and secure the electrode tabs. In a case of such a configuration capable of electrically connecting and physically securing the electrode tabs by passing the terminal members 311 and 315 therethrough, there is no need to separately provide members serving the respective roles, which is advantageous in simplification of the configuration and reduction in the number of components.

The terminal parts 311a and 315b of the terminal members 311 and 315 are positioned on an outer face of the casing 310 in an assembled state. The terminal part 311a is a terminal for positive electrode, and the terminal part 315a is a terminal for negative electrode. For example, by connecting the terminal parts 311a and 315a by wiring, the adjacent battery packs 301 are electrically connected to each other in sequence.

Note that although not illustrated in FIGS. 10A and 10B, a member for holding and securing the plurality of stacked film packed batteries 50 to one other may be provided.

The plurality of thus-fabricated battery packs 301 are gathered to constitute an assembled battery, thereby forming the power supply unit 1A. The battery packs 301 are arranged flat in one layer in FIG. 10D, but may be configured to be stacked in two or more layers as well.

According to the configuration of the thus-configured battery unit according to one mode of the present invention, since the above-described film packed battery according to one mode of the present invention is used, the battery unit having a fuse function has high reliability that is less likely to cause breakage or damage of the electrode tab even when any kind of force is applied from outside.

Note that the electrode tabs 21 and the electrode tabs 25 of all the film packed batteries 50 are led out in the same direction in the above description, but as another example, the electrode tabs 21 and the electrode tabs 25 of some of the film packed batteries 50 may be led out in a direction different from that in which the electrode tabs 21 and the electrode tabs 25 of another some of the film packed batteries 50 are led out (in an example, in opposite directions).

### (Second Aspect)

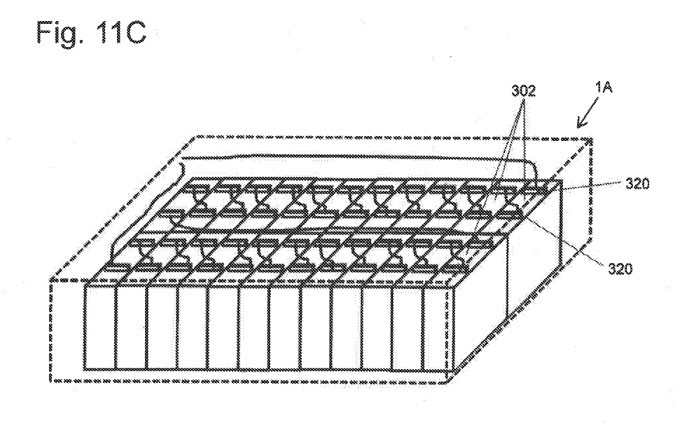

FIGS. 11A to 11C illustrate a second aspect. As illustrated in FIG. 11C, the power supply unit 1B includes a plurality of battery packs 302. The power supply unit according to the second aspect and the power supply unit according to the first aspect are different in (i) the arrangement position of the terminal part for electrical connection and the connection configuration between the terminal member and the electrode tab, and (ii) the orientation of arrangement of the battery pack. Other than the above points, the power supply unit according to the second aspect has a configuration in common with the power supply unit according to the first aspect. Repeated description about a common part will be omitted.

In the first aspect, as has been illustrated in FIG. 10B, the terminal parts 311a and 315a for electrical connection are positioned on a top face (a face with the maximum area) of the casing 310. However, in the example, terminal parts for electrical connection are positioned on a side face (that may be any one of a side face on a long side and a side face on a short side) of the casing 310 (see FIGS. 11A and 11B).

A terminal member 320 includes a terminal part 320a for electrical connection, and a plurality of electrically connecting parts 320b extending from the terminal part 320a. The terminal part 320a is positioned on a side face of the casing 310 in a state attached with the terminal member 320. On the other hand, the electrically connecting part 320b extends into the casing and a part on the leading end side of the electrically connecting part 320b is electrically connected to the electrode tab 21, 25 of the film packed battery 50.

When describing the electrode tab 21 of a negative electrode as an example, as illustrated in FIG. 11B, the leading end side of the electrode tab 21 of each of the piled film packed batteries 50 is bent, and the opening 21h is formed on the bent part. The bent part may be, but not limited to be, substantially parallel to a face of the casing 310 to which the terminal member 320 is attached. According to such a configuration, the openings 21h of the respective electrode tabs 21 open toward the terminal member 320 in an aligned state. The terminal member 320 has the connecting parts 320b in the number corresponding to the number of the electrode tabs 21.

The electrically connecting part 320b may be a screw of a conductive material and the like in an example, and by passing the leading end side of the electrically connecting part 320b through the opening 21h of the electrode tab 21 and then securing the electrically connecting part 320b, the electrode tab 21 and the connecting part 320b are electrically connected. As a matter of course, another fixture may be used in combination to connect between the both members.

The connecting part 320b is preferably configured to serve roles for both electrical connection and physical securing. In this case, there is no need to separately provide members serving the roles, which is advantageous in simplification of the configuration and reduction in the number of components. In the above, description has been given using the electrode tab 21 and the like as an example. However, the electrode tab 25 on the other side can be configured in the same manner.

The thus-fabricated battery packs 302 are arranged to constitute an assembled battery in a state that the terminal members 320 of the battery packs 302 are located top side, thereby forming the power supply unit 1A (FIG. 11C). Arrangement and alignment of the battery packs 302 are not particularly limited. In the example, the plurality of aligned battery packs 302 are arranged in two rows. As a matter of course, the plurality of aligned battery packs 302 may be arranged in one row, or in three or more rows. By connecting between the positive-electrode terminal parts 320a and between the negative-electrode terminal parts 320a in the adjacent battery packs by wiring, the plurality of battery packs 302 are electrically connected in sequence.

### (Supplementary Notes)

The following invention is disclosed herein:

1. A secondary battery (50) including:

a battery element (20);

a housing (10) that houses the battery element (20) and an electrolyte solution; and

electrode tabs (21 and 25) of a positive electrode and a negative electrode that are led out from the housing (10),

the secondary battery further including:

a fusing part (25b) that is formed on a part of the electrode tab and preferentially fuses rather than another region when a predetermined current flows; and

a reinforcing member (31, 33, 35) that is attached to the electrode tab at a section including at least the fusing part (25b) in a state that the reinforcing member is distant from the housing.

2. The reinforcing member (31) is a member (33) disposed on one face of the electrode tab.
3. The reinforcing member (31) is a hollow member (35) through which the electrode tab is inserted.
4. The reinforcing member and the electrode tab are mechanically coupled.
5. The mechanical coupling is performed by locking a part of the electrode tab and a part of the reinforcing member.
6. The mechanical coupling is performed by a fixture (61).
7. The mechanical coupling is performed on both sides of the fusing part (25b).
8. The reinforcing member is a thermal insulation material.
9. The reinforcing member is a ceramic or a flame-retardant resin.
10. The housing is a film housing.
11. The fusing part (25b) is distant by a predetermined distance from a welding part of the film housing sandwiching the electrode tab.
12. An electric vehicle including a power supply unit (1A, 2A) that includes a plurality of the above-described secondary batteries.
13. A power storage system including a power supply unit (1A, 2A) that includes a plurality of the above-described secondary batteries.
14. A method of manufacturing a secondary battery, including the steps of:

preparing a battery element;

enclosing the battery element and an electrolyte solution in a housing;

forming, on a part of an electrode tab, a fusing part that preferentially fuses rather than another region when a predetermined current flows; and

attaching a reinforcing member to the electrode tab at a section including at least the fusing part in a state that the reinforcing member is distant from the housing.

15. A secondary battery (50) including:

a battery element (20);

a housing (10) that houses the battery element (20) and an electrolyte solution; and

electrode tabs (21 and 25) of a positive electrode and a negative electrode that are led out from the housing (10),

the secondary battery further including:

a fusing part (75b) that is formed on another conducting material (75) connected to the electrode tab and preferentially fuses rather than another region when a predetermined current flows; and

a reinforcing member (33) that is attached to the electrode tab and/or the other conductive member at a section including at least the fusing part in a state that the reinforcing member is distant from the housing. The “fusing part” may be provided on a member other than the tab in this manner.

### REFERENCE SIGNS LIST

1 Power storage system (Power storage equipment)
1A, 1B Power supply unit
1B Control device
2 Electric vehicle
2A Power supply unit
10 Film housing
11, 12 Film
15 Thermal welding part
20 Battery element
21, 25 Electrode tab
25a Slit
25a′ Opening
25b Fusing part
25e Locking piece
25h Through hole
31, 33, 35 Reinforcing member
33h Through hole
33a Recess
35a Internal space
35h Through hole
50 Film packed battery
61 Fixture
75, 76-1, 76-2 Conductive member
75h, 76h Through hole
301, 302 Battery pack
310 Casing
311, 315 Terminal member
311a, 315a, 320a Terminal part
311b, 311b, 320b Electrically connecting part

1. A secondary battery comprising:
a battery element;
a housing that houses the battery element and an electrolyte solution; and
electrode tabs of a positive electrode and a negative electrode that are led out from the housing,
the secondary battery further comprising:
a fusing part that is formed on a part of the electrode tab and preferentially fuses rather than another region when a predetermined current flows; and
a reinforcing member that is attached to the electrode tab at a section including at least the fusing part in a state that the reinforcing member is distant from the housing.

2. The secondary battery according to claim 1, wherein
the reinforcing member is a member disposed on one face of the electrode tab.

3. The secondary battery according to claim 1, wherein
the reinforcing member is a hollow member through which the electrode tab is inserted.

4. The secondary battery according to claim 1, wherein
the reinforcing member and the electrode tab are mechanically coupled.

5. The secondary battery according to claim 4, wherein
the mechanical coupling is performed by locking a part of the electrode tab and a part of the reinforcing member.

6. The secondary battery according to claim 4, wherein
the mechanical coupling is performed by a fixture.

7. The secondary battery according to claim 4, wherein
the mechanical coupling is performed on both sides of the fusing part.

8. The secondary battery according to claim 1, wherein
the reinforcing member is a thermal insulation material.

9. The secondary battery according to claim 1, wherein
the reinforcing member is a ceramic or a flame-retardant resin.

10. The secondary battery according to claim 1, wherein
the housing is a film housing.

11. The secondary battery according to claim 10, wherein
the fusing part is distant by a predetermined distance from a welding part of the film housing sandwiching the electrode tab.

12. An electric vehicle comprising a power supply unit that includes a plurality of the secondary batteries according to claim 1.

13. A power storage system comprising a power supply unit that includes a plurality of the secondary batteries according to claim 1.

14. A method of manufacturing a secondary battery, comprising:
preparing a battery element;
enclosing the battery element and an electrolyte solution in a housing;
forming, on a part of an electrode tab, a fusing part that preferentially fuses rather than another region when a predetermined current flows; and
attaching a reinforcing member to the electrode tab at a section including at least the fusing part in a state that the reinforcing member is distant from the housing.

15. A secondary battery comprising:
a battery element;
a housing that houses the battery element and an electrolyte solution; and
electrode tabs of a positive electrode and a negative electrode that are led out from the housing,
the secondary battery further comprising:
a fusing part that is formed on other conductive member connected to the electrode tab and preferentially fuses rather than another region when a predetermined current flows; and
a reinforcing member that is attached to the electrode tab and/or the other conductive member at a section including at least the fusing part in a state that the reinforcing member is distant from the housing.
